(19) United States
(12) Patent Application Publication
(10) Pub. No.: US 2006/0085297 A1
(43) Pub. Date: Apr. 20, 2006

(54) Customer interaction with inventory via RFID

(75) Inventor: Kevin G. Minerley, Red Hook, NY (US)

Correspondence Address: CANTOR COLBURN LLP, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 10/965,332

(22) Filed: Oct. 14, 2004

(51) Int. Cl. G06E 1/00

(52) U.S. Cl. 705/28

(57) ABSTRACT

Customer interaction with inventory via radio frequency identification (RFID) are disclosed, where a unique RFID is combined into ID cards, credit, debit, and smartcards. The current inventory RFID technology and RFID reader are moved into a place convenient to the end-user or customer to remove the need for cashiers. Some applications include point-of-sale terminals, libraries, tool cribs, and places where customers or end-users remove items from inventories and inventories need to be monitored.

### BACKGROUND OF THE INVENTION

1. Field of the Invention

The present invention relates generally to human interfaces, inventory, and retailing sales, including point-of-sale terminals and, in particular, to libraries, tool cribs, and any other place where customers or end-users remove items from inventories and inventories need to be monitored.

2. Description of Related Art

Radio frequency identification (RFID) is a technology that incorporates the use of electromagnetic or electrostatic coupling in the radio frequency (RF) portion of the electromagnetic spectrum to uniquely identify an object, animal, or person. RFID is coming into increasing use in industry as an alternative to the bar code. One advantage of RFID over the bar code is that it does not require direct contact or line-of-sight scanning. An RFID system typically consists of three components: an antenna and transceiver (often combined into one reader) and a transponder (tag). The antenna uses radio frequency waves to transmit a signal that activates the transponder. When activated, the tag transmits data back to the antenna. The data is used to notify a device, such as a programmable logic controller that an action should occur. The action could be as simple as raising an access gate or as complicated as interfacing with a database to carry out a monetary transaction. There are various kinds of RFID systems, including low frequency and high-frequency systems. Low-frequency RFID systems (30 KHz to 500 KHz) have short transmission ranges (generally less than six feet). High-frequency RFID systems (850 MHz to 950 MHz and 2.4 GHz to 2.5 GHz) offer longer transmission ranges (more than 90 feet). In general, the higher the frequency, the more expensive the system is. RFID is sometimes called dedicated short-range communication (DSRC).

Much check-out work either in libraries or stores today is mindless work where the librarian or cashier simply scans books or inventory items that the customer has chosen. The customer, in turn, often swipes an ID card or credit card in order to acquire this inventory. There is a need to automate more of the mindless work using computing devices and RFID transceivers. Furthermore, there is a need to physically move the work to where it is mostly naturally likely to take place, either in a static location, such as at an exit, or dynamically in specialized shopping carts or with specialized mobile cell phones.

### BRIEF SUMMARY OF THE INVENTION

The present invention is directed to methods, computer-readable mediums, systems, shopping carts, cell phones, and exit areas for interaction with inventory that satisfies these needs and others.

A first aspect is a method for interaction with inventory. An inventory RFID tag and a personal RFID tag are read in proximity to an RFID reader. The inventory RFID tag identifies an inventory item and the personal RFID tag identifies a personal item. The inventory item is associated with the personal item. The inventory item is checked out to the personal item.

Another aspect is a computer-readable medium having instructions for performing a method of interaction with inventory. An inventory RFID tag and a personal RFID tag are read in proximity to an RFID reader. The inventory RFID tag identifies an inventory item and the personal RFID tag identifies a personal item. The inventory item is associated with the personal item. The inventory item is checked out to the personal item.

Yet another aspect is a system for interaction with inventory that includes one or more inventory items, a check-out system, and one or more exit areas. The inventory items have inventory RFID tags. The check-out system includes at least one RFID reader. The RFID reader reads the inventory RFID tag and a personal RFID tag on a personal item. The check-out system associates the personal item with the inventory items when they are in proximity to the RFID reader. The exit areas are in communication with the check-out system. The exit areas allow passage of the person interacting with the inventory in response to a signal from the check-out system.

Still another aspect is a shopping cart for interaction with inventory that includes a holder and a list-making component. The holder receives at least one acquired item from a plurality of inventory items having inventory RFID tags. Acquired items have been read by an RFID reader. The list-making component creates and maintains an interim list of the at least one acquired item. The list-making component also provides a final list for reconciliation. The interim list associates the acquired item with a personal item having a personal RFID tag. The personal RFID tag is read by the RFID reader.

Still another aspect is a cell phone for interaction with inventory. The cell phone includes a list-making component and an RFID reader. The list-making component creates and maintains an interim list of acquired items from a plurality of inventory items having inventory RFID tags. The list-making component also provides a final list for reconciliation. The interim list associates at least one inventory item having at least one inventory RFID tag with a personal card having a personal RFID tag. The RFID reader reads the inventory RFID tag and the personal RFID tag, when the inventory RFID tag and the personal RFID tag are in proximity to the RFID reader.

Still another aspect is an exit area for interaction with inventory. The exit area includes an RFID reader, a check-out component, and a sensor. The RFID reader reads a personal card having a personal RFID tag and at least one inventory item having at least one inventory RFID tag, when the personal card and the at least one inventory item are in proximity to the RFID reader. The check-out component automatically checks-out the inventory item to the personal card, after the personal RFID tag and the inventory RFID tag are read by the RFID reader. The check-out component is in communication with the RFID reader. The check-out component receives information associated with the personal card and the inventory item from the RFID reader. The sensor operates at least one exit way upon receiving a signal from the check-out component. The sensor is in communication with the check-out component.

### BRIEF DESCRIPTION OF THE DRAWINGS

These and other features, aspects, and advantages of the present invention will become better understood with regard to the following description, appended claims, and accompanying drawings, where:

FIG. 1 is a block diagram showing an exemplary method for interaction with inventory;

FIG. 2 is a block diagram showing another exemplary method for interaction with inventory;

FIG. 3 is a block diagram showing an exemplary computer-readable medium having instructions for performing a method of interaction with inventory;

FIG. 4 is a block diagram showing an exemplary system for interaction with inventory;

FIG. 5 is a block diagram showing an exemplary shopping cart for interaction with inventory;

FIG. 6 is a block diagram showing another exemplary shopping cart for interaction with inventory;

FIG. 7 is a block diagram showing an exemplary cell phone for interaction with inventory; and

FIG. 8 is a block diagram showing an exemplary exit area for interaction with inventory.

### DETAILED DESCRIPTION OF THE INVENTION

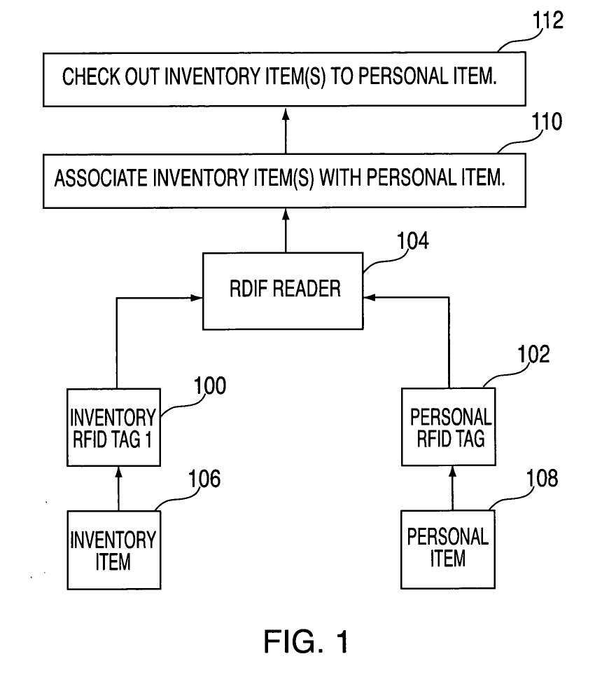

FIG. 1 shows an exemplary method for interaction with inventory. An inventory RFID tag 100 and a personal RFID tag 102 are read by an RFID reader 104. The inventory RFID tag 100 identifies an inventory item 106 and the personal RFID tag 102 identifies a personal item 108. At 110, the inventory item 106 is associated with the personal item 108 and, then at 112, the inventory item 106 is checked-out to the personal item 108.

Many different kinds of RFID tags 102, RFID readers 104, and other RFID technologies may be used in embodiments of the present invention to operate in shopping carts, cell phones, exit or entry areas of a facility, and in various other ways.

Various embodiments of the present invention operate, at least in part, according to standards, such as JTC 1/SC 31 Automatic identification and data capture techniques, JTC 1/SC 17 Identification Cards and related devices, ISO TC 104/SC 4 Identification and communication, ISO TC 23/SC 19 Agricultural electronics, CEN TC 278 Road transport and Traffic Telematics, CEN/TC 23/SC 3/WG 3 Transportable Gas Cylinders—Operational Requirements—Identification of cylinders and contents, ISO/TC204 Transport Information and Control Systems, European Telecommunications Standards Institute (ETSI), European Radiocommunications Office (ERO), American National Standards Institute (ANSI), Universal Postal Union, and American Society for Testing and Materials (ASTM), among other standards.

Personal items 108 include, for example, a retail store customer card, a credit card, a debit card, a smartcard, a library card, a computing device, a cell phone, and many other kinds of cards and devices associated with inventory, customers, retail, leasing and the like. One advantage of having the personal RFID tag 102 on, for example, an identification card is that a person carrying the identification card need not take the identification card out for it to be read by the RFID reader 104. In one embodiment, the personal item 108 is read upon entry to a facility and, then, upon exit associated with at least one inventory item 106.

There are several exemplary ways the personal item 108, such as an identification card, can be associated with the inventory item 106. First, the personal item 108 and the inventory item 106 can be associated with each other because they are in proximity to each other during one or more readings by the RFID reader 104. For example, when a person carrying the personal item 108 and the inventory item 106 approaches the RFID reader at an exit area, the RFID reader reads them both and associates them. If the person is carrying a plurality of personal items 108, a computing machine can provide a selection by the person. If a specific type of personal item 108 is required by the facility, say a library card, then that one can be selected automatically from among a number of personal items 10 by the computing machine and optionally confirmed by the person.

A second exemplary way the personal item 108 can be associated with the inventory item 106 is through a shopping cart that is specially adapted to recognize particular events. An event is recognized, for example, when the inventory item 106 is placed in the cart and the inventory item is associated to the personal item, in response to the event. Then, there is a final reconciliation at an exit area for inventory control, in this example. Preferably, the reconciliation only occurs at the exit area to reduce computation and complexity.

A third exemplary way the personal item 108 can be associated with the inventory item 106 is by proximity to the RFID reader 104, check-out system or exit area. For example, when a person carrying his library card and a stack of books enters a revolving door exit, a check-out system can associate the books with the library card, automatically check them out, and signal for the door to open. Alternatively, if, for example, the library card was expired, the check-out system could signal the revolving door to only permit the person to go back into the library and, optionally sound an alarm or alerting device.

A fourth exemplary way the personal item 108 can be associated with the inventory item 106 is through using a cell phone having the RFID reader 104 on it and specialized software that, optionally, may interact with a check-out system in a facility. For example, a person could avoid a movie line by using his cell phone to read the personal RFID tag 102 on his credit card, select a movie, and send the information to the cashier system, receiving in return an electronic ticket for entrance into the movie on his cell phone that, perhaps, interacts with a turnstile letting him enter the theatre. Of course, there are other ways the personal item 108 can be associated with the inventory item 106.

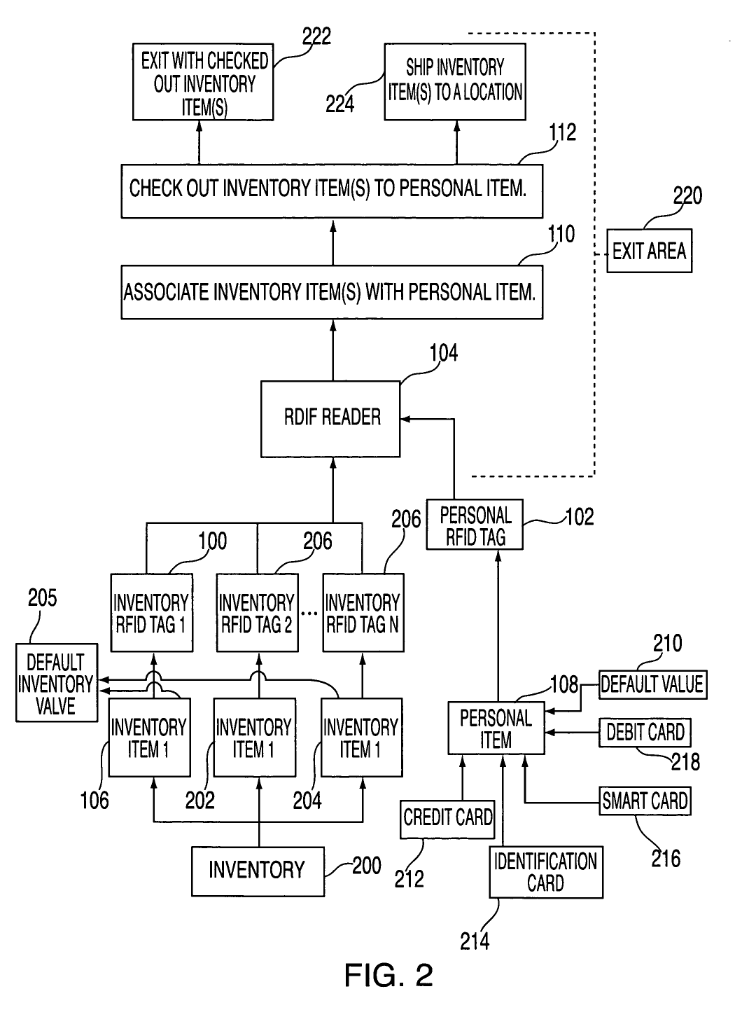

FIG. 2 shows another exemplary method for interaction with inventory. In this exemplary method, there is an inventory 200 with a number of inventory items, {inventory item one 106, inventory item two 202, . . . inventory item n 204}. Initially, each inventory item 106, 202, 204 is associated with a default inventory value 205. With the default inventory value 205, the inventory system can identify by reading and keep track of inventory items 102, 202, 204 that have not yet been associated with RFID tags. Each inventory item 106, 202, 204 is later associated with a unique inventory RFID tag so that inventory item one 106 is associated with inventory RFID tag 100, inventory item two 202 is associated with inventory RFID tag 206, . . . and inventory item n 204 is associated with inventory RFID tag 208.

Initially, the personal item 108 is associated with a default value 210, in this exemplary method. The default value may be a security code or identifier. The personal item 108 is later associated with one or more personal cards, such as a credit card 212, an identification card 214, a smart card 216, and a debit card 218. The personal item 108 may be associated with the cards 12, 214, 216, 218 through a cell phone, cashier system, the Internet, or any other association method. Other kinds of cards may also be associated with the credit card in this exemplary method.

In an exit area 220, the inventory RFID tags 100, 206, 208 are read by the RFID reader 104 and the corresponding inventory items 106, 202, 204 are associated to the personal item 108. This may be done automatically when the items are in proximity to the RFID reader 104 or at some signal from a processor in the exit area, such as a check-out machine. Non-portable inventory items may be represented by tokens having an RFID tag. If any of the inventory items 106, 202, 204 is associated with the default inventory value 205, a notification may be issued for assistance in the exit area 220.

Before check-out, the inventory items may be provided for review on a display in the exit area 220. For example, the check-out may request an acknowledgement, for example, swiping the personal item 108 or an associated card. Some sort of acknowledgement may be requested even to associate inventory items 106, 202, 204 to the personal item 108. The acknowledgement may be an agreement to sale terms, contract terms, license terms, or the like.

After association, the inventory items 106, 202, 204 are checked-out to the personal item 108. In an Internet application, for example, the inventory item may be shipped to a specified location 224, after check-out. The person may be permitted to leave the exit area 220 after check-out by, for example, opening a door 222. If there are any problems encountered during association or check-out, the person may be detained in the exit area 220, alarms may sound, or notifications may be issued.

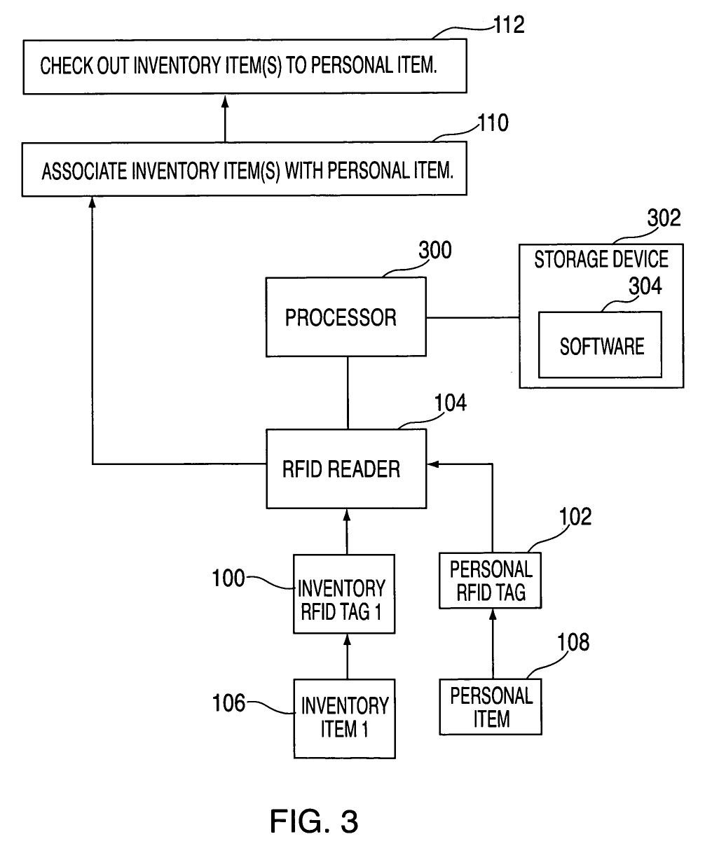

FIG. 3 shows an exemplary computer-readable medium having instructions for performing a method of interaction with inventory. In FIG. 3, a processor 300 accesses a storage device 302 holding instructions in software 304 for performing a method of interaction with inventory. The storage device 302 may be a memory in the processor 300, a CD, or any other kind of storage. The processor 300 may be in the exit area 220 or be associated with or a part of the RFID reader 104, a cell phone, or another kind of machine. The RFID reader 104 could be part of the cell phone. The processor 2300 may be in any kind of facility, such as a library, retail store, or tool crib.

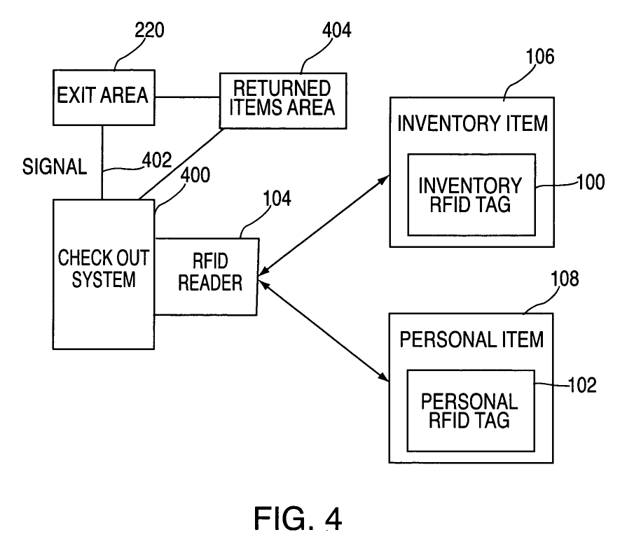

FIG. 4 shows an exemplary system for interaction with inventory. The system includes one or more inventory items 106 having inventory RFID tags 100, a check-out system 400, and at least one exit area 220. The check-out system 400 includes at least one RFID reader 104. The RFID reader 104 reads the inventory RFID tag(s) 100 and the personal RFID tag 102 on the personal item 108, when they are in proximity to the RFID reader 104. The check-out system 400 associates the inventory item(s) 106 to the personal item 108.

The exit area 220 communicates with the check-out system 400 and allows passage, in response to a signal 402 from the check-out system 400. Passage may be allowed by, for example, opening a door or operating a revolving door. The signal may be an indication of agreement to the association and check-out. The exit area 20 may be adapted to existing equipment in a retail store, a library, a tool crib, or any other kind of facility. The door may be coupled to one or more check-out queue to maximize throughput.

A returned items area 404, such as a drop box receives returned items. The returned items area 404 may automatically de-associate the returned inventory item 106 from the personal item 108 by communicating with the check-out system 400 and/or exit area 220.

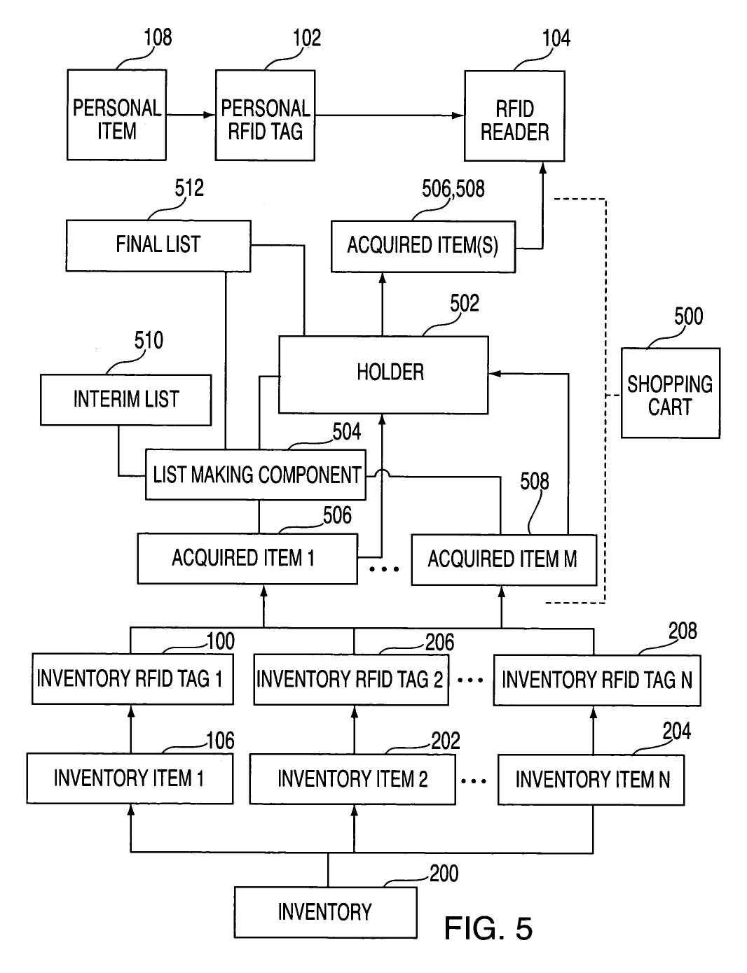

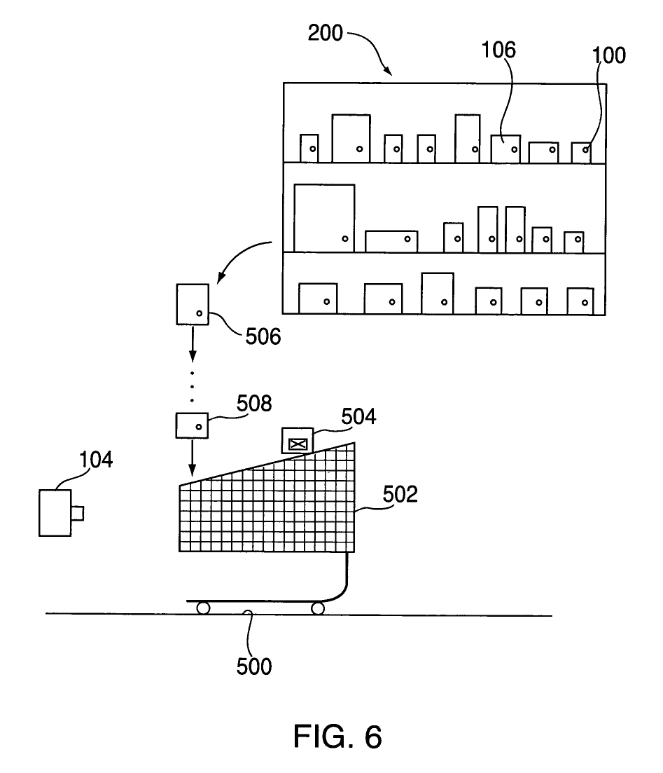

FIGS. 5 and 6 show an exemplary shopping cart 500 for interaction with inventory. The shopping cart 500 includes a holder 502 and a list-making component 504.

The holder 502 receives acquired items, {acquired item one 506 . . . acquired item M 508}, from inventory. Acquired items 506, 508 may be read with the RFID reader 104 at some point, such as when placed in the holder 502. In a web application, the holder may be virtual and represented on a web page.

The list-making component 504 may include the RFID reader 104. Alternately, the RFID reader 104 may be coupled to a part of the shopping cart 500, say the holder 502 or the RFID reader 104 may be on a cell phone, with another device. The list-making component 504 creates and maintains an interim list 510 of acquired items 506, 508 and also provides a final list 512 for reconciliation. The interim list 510 may associate acquired items to the personal item 108 or this may be done later at, say the exit area 220 or upon request by a person, machine, or device. In a web application, the list-making component 504 may be associated with a web page, icon, or the like.

The exit area 220 receives the final list 512 and requests an indication of agreement. The exit area 220 may have a number of exits in communication with the list-making component 504 to allow passage only after a valid sale. An alarm may be sounded by the list-making component 504 or the exit area 220 upon an invalid sale.

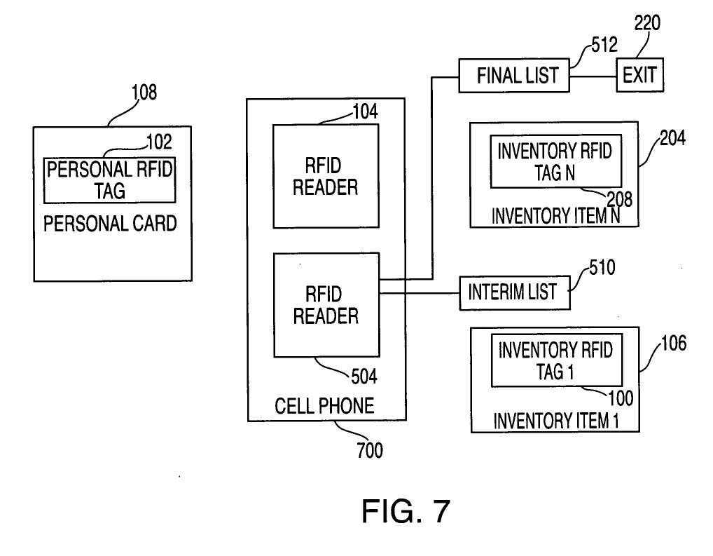

FIG. 7 shows an exemplary cell phone 700 for interaction with inventory. The cell phone 700 includes a list-making component 504 and an RFID reader 104. An interim list 510 is created and then the cell phone 700 sends the final list 512 and an indication of agreement to the exit area 220.

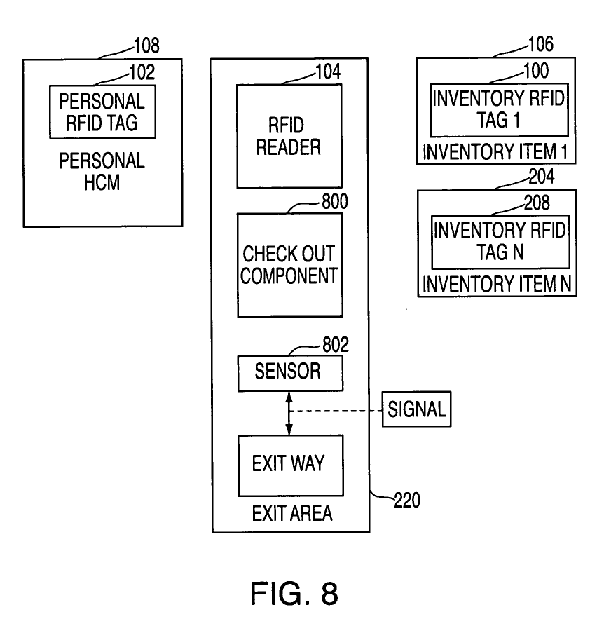

FIG. 8 shows an exemplary exit area 220 for interaction with inventory. The exit area 220 includes the RFID reader 104, a check-out component 800, and a sensor 802. The RFID reader 104 reads RFID tags 102, 100, 208 for the personal card 108 and inventory item(s) 106, 204 when they are in proximity to the RFID reader 104.

The check-out component 800 automatically checks out the inventory items 106, 204 to the personal item 108, after they are read by the RFID reader 104. The check-out component 800 communicates with the RFID reader 104 and receives information associated with the personal item 108 and the inventory item(s) 106,204 from the RFID reader 104.

The sensor 802 operates one or more exit ways upon receiving a signal from the check-out component 800 and may receive other information from the check-out component 800. For example, the check-out component may send a signal to the sensor 802 after receiving a confirmation, such as a personal card swipe or entry of a personal identification number (PIN).

One use case or scenario includes on entry to a facility, reading all RFIDs on a person, on exit, read all RFIDs on the person, associate the two and provide the association for reconciliation by the person. After reconciliation, depending on the application, a sale may take place using a payment method associated with one of the RFIDs on the person. For a library application, media would be checked out to the person's library card. For a tool shed application, tools that had left the inventory would be associated with the person. Of course, there are many applications for this exemplary method embodiment of the present invention.

In another scenario: on exit only, read all RFIDs on the person and all RFIDs in proximity to the person, associate the two and provide the association for reconciliation by the person. Do not allow exit until the association is confirmed by the person. In another embodiment, exit is allowed, however an alarm or other notice is provided of a potential shoplifting event. In one embodiment, it is determined which items were brought into the facility, which are not part of the inventory at the facility.

In another scenario, each RFID has a unique identifier. A computing device receiving an RFID reading is able to check what the RFID is associated with and perform the appropriate action. In this exemplary system, there is a database searchable by RFID identifiers. In another exemplary system, an RFID reader selectively reads RFIDs according to their type. For example, in a library application, a library RFID reader only reads the library card RFID on the person and ignores other RFIDs, such as credit cards, protecting the privacy of the person. In the library application, the unique identifier associated with the library card RFID need only be unique to a particular library. In a retail sales application, each credit card RFID for each person needs to be unique.

In another scenario, the person makes a virtual entry into and virtual exit from a virtual inventory, associating inventory to personal items.

Another scenario includes a cell phone used as a smartcard or credit card. The cell phone is associated with information, such as GPS tracking information, owner identify information, and the like. For example, the person walks into a library with his cell phone on, browses, picks up four books, walks out of the library, and the exemplary system automatically checks the four books out on the library account associated with the cell phone. In another example, the person walks into a convenience store with his cell phone on, picks up a food item, walks out of the store, and the exemplary system automatically charges the food item to a debit card associated with an RFID tag on the person. In another example, the person walks into a toy store, picks up a token having an RFID tag that is associated with a toy too large to carry, walks to the exit area, and the exemplary system automatically provides a selection of a credit card or debit card associated with the cell phone for purchasing the toy. In one embodiment, the cell phone has text message and review capability so that the person can review the purchase and order anything he forgot.

The exemplary embodiments of the present invention have many advantages, including minimizing shop-lifting by not allowing exit unless a customer's card were associated with the inventory at the point of exit. Moving the work to where it is mostly naturally likely to take place, either in a static location, such as at an exit, or dynamically in specialized shopping carts or with specialized mobile cell phones, has the advantage of virtually as many check-out queues as there are customers. Another advantage is the automation of check out jobs so that a person need not even check himself out, but is automatically scanned. Another advantage is allowing multiple queues and multiple exits, preventing bottlenecks that typically occur at single exits.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. For example, various personal items other than types of cards may be used for practicing various embodiments of the present invention. In addition, future improvements or changes to standards may be used with minor adaptations of various embodiments of the present invention. Furthermore, various components may be implemented in hardware, software, or firmware or any combination thereof. Finally, many modifications may be made to adapt a particular situation or material to the teachings of the invention without departing from the essential scope thereof. Therefore, it is intended that the invention is not to be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for interaction with inventory, comprising:
reading an inventory radio frequency identification (RFID) tag and a personal RFID tag in proximity to an RFID reader, the inventory RFID tag identifying an inventory item, the personal RFID tag identifying a personal item;
associating the inventory item with the personal item; and
checking-out the inventory item to the personal item.

2. The method of claim 1, further comprising:
associating the inventory RFID tag with the inventory item.

3. The method of claim 1, further comprising:
associating the personal RFID tag with the personal item.

4. The method of claim 1, wherein checking-out the inventory item to the personal item occurs automatically in proximity to an exit area.

5. The method of claim 1, further comprising:
associating unique RFID tags with each inventory item in an inventory.

6. The method of claim 5, further comprising:
reading a plurality of inventory RFID tags;
associating a plurality of corresponding inventory items to the personal item; and
checking-out the plurality of corresponding inventory items to the personal item.

7. The method of claim 6, further comprising:
providing the associated inventory items for review, before check-out.

8. The method of claim 5, wherein non-portable inventory items are represented by inventory items having RFID tags that are tokens.

9. The method of claim 5, further comprising:
associating each inventory RFID tag initially to a default value.

10. The method of claim 1, wherein the personal item is a personal card.

11. The method of claim 10, further comprising:
swiping the personal card to associate the inventory item to the personal card.

12. The method of claim 10, wherein the personal card is one of: a credit card, a debit card, a smart card, or an identification card.

13. The method of claim 1, further comprising:
receiving an acknowledgement before associating the inventory item with the personal item.

14. The method of claim 1, further comprising:
receiving an acknowledgement before checking-out the inventory item to the personal item.

15. The method of claim 14, wherein the acknowledgement is an agreement to sale terms, contract terms, or license terms.

16. The method of claim 1, further comprising:
shipping the inventory item to a location.

17. A computer-readable medium having instructions for performing a method of interaction with inventory, the method comprising:
reading an inventory RFID tag and a personal RFID tag in proximity to an RFID reader, the inventory RFID tag identifying an inventory item, the personal RFID tag identifying a personal item;
associating the inventory item with the personal item; and
checking-out the inventory item to the personal item.

18. The method of claim 17, wherein the inventory item is a book in a library.

19. The method of claim 17, wherein the inventory item is a piece of merchandise in a retail store.

20. The method of claim 17, wherein the inventory item is a tool in a tool crib.

21. The method of claim 17, wherein the RFID reader is part of a cell phone.

22. A system for interaction with inventory, comprising:
at least one inventory item having an inventory RFID tag;
a check-out system including at least one RFID reader, the at least one RFID reader for reading the inventory RFID tag and a personal RFID tag on a personal item, the check-out system for associating the personal item with the at least one inventory item in proximity to the RFID reader; and
at least one exit area in communication with the check-out system, the at least one exit area allowing passage, in response to a signal from the check-out system.

23. The system of claim 22, wherein the exit area is adapted for a retail store, a library or a tool crib.

24. The system of claim 22, wherein the personal item is a personal card, a credit card, a debit card, a smart card, a cell phone, or an identification card.

25. The system of claim 22, wherein the at least one exit area includes at least one door, the at least one door opening in response to the signal.

26. The system of claim 25, wherein the door is a revolving door.

27. The system of claim 25, wherein the at least one door is coupled to at least one check-out queue.

28. The system of claim 27, wherein the at least one check-out queue maximizes throughput.

29. The system of claim 27, wherein the signal is an indication of agreement to the associating and checking-out.

30. The system of claim 22, further comprising:
a returned items area for receiving at least one returned item of the at least one inventory item and de-associating the at least one returned item from the personal item.

31. The system of claim 30, wherein the returned items area is a drop box.

32. A shopping cart for interaction with inventory, comprising:
a holder for receiving at least one acquired item from a plurality of inventory items having inventory RFID tags, the at least one acquired item having been read by an RFID reader; and
a list-making component for creating and maintaining an interim list of the at least one acquired item and for providing a final list for reconciliation, the interim list associating the at least one acquired item with a personal item having a personal RFID tag, the personal RFID tag being read by the RFID reader.

33. The shopping cart of claim 32, wherein the RFID reader is coupled to the holder.

34. The shopping cart of claim 32, wherein the RFID reader is coupled to the list-making component.

35. The shopping cart of claim 32, wherein the RFID reader is coupled to a cell phone.

36. The shopping cart of claim 32, further comprising:
an exit for receiving the final list and receiving an indication of agreement.

37. The shopping cart of claim 32, wherein the holder is virtual and represented on a web page and the list-making component is associated with the web page.

38. The shopping cart of claim 32, wherein the holder is physical and coupled to the list-making component.

39. The shopping cart of claim 32, further comprising a plurality of exits in communication with the list-making component that allow passage upon a valid sale.

40. The shopping cart of claim 39, wherein the exits do not allow passage upon an invalid sale.

41. The shopping cart of claim 39, wherein the exits set an alarm upon an invalid sale.

42. The shopping cart of claim 32, wherein the at least one acquired item is read by the RFID reader when the at least one acquired item is placed in the holder.

43. A cell phone for interaction with inventory, comprising:
a list-making component for creating and maintaining an interim list of acquired items from a plurality of inventory items having inventory RFID tags and for providing a final list for reconciliation, the interim list associating at least one inventory item having at least one inventory RFID tag with a personal card having a personal RFID tag; and
an RFID reader for reading the at least one inventory RFID tag and the personal RFID tag, when the at least one inventory RFID tag and the personal RFID tag are in proximity to the RFID reader.

44. The cell phone of claim 43, wherein the list-making component sends the final list and an indication of agreement to an exit.

45. An exit area for interaction with inventory, comprising:
an RFID reader for reading a personal card having a personal RFID tag and at least one inventory item having at least one inventory RFID tag, when the personal card and the at least one inventory item are in proximity to the RFID reader;
a check-out component for automatically checking-out the at least one inventory item to the personal card, after the personal RFID tag and the at least one inventory RFID tag are read by the RFID reader, the check-out component being in communication with the RFID reader and receiving information associated with the personal card and the inventory item from the RFID reader; and
a sensor for operating at least one exit way upon receiving a signal from the check-out component, the sensor being in communication with the check-out component.

46. The exit of claim 45, wherein the check-out sends the signal to the sensor after receiving a confirmation.

47. The exit of claim 46, wherein the confirmation is a swipe of the personal card.

48. The exit of claim 46, wherein the confirmation is a personal identification number (PIN).
